(19) United States
(12) Patent Application Publication
(10) Pub. No.: US 2025/0315448 A1
(43) Pub. Date: Oct. 9, 2025

(54) EVALUATING EXPLAINABLE ARTIFICIAL INTELLIGENCE MODELS AND AN ARCHITECTURE FOR AN ENSEMBLE EXPLAINABLE MODEL SELECTION

(71) Applicant: U.S. Bancorp, National Association, Minneapolis, MN (US)

(72) Inventors: Sherin Mathews, Fremont, CA (US); Samuel Assefa, Watertown, MA (US)

(73) Assignee: U.S. Bancorp, National Association, Minneapolis, MN (US)

(21) Appl. No.: 18/630,669

(22) Filed: Apr. 9, 2024

(51) Int. Cl. G06F 16/28

(52) U.S. Cl. CPC G06F 16/285; G06N 5/02; G06N 5/045; G06N 20/00

(57) ABSTRACT

A system includes one or more processors to store a first explanatory model (e.g., a SHAP model or a LIME model) and a second explanatory model; execute the machine learning model (e.g., a neural network) using a first set of data to generate a first classification data point; generate a first plurality of explanatory evaluation metrics for the first explanatory model by applying the first explanatory model to the first classification data point; and responsive to the first plurality of explanatory evaluation metrics satisfying an explanatory model selection policy, apply the first explanatory model and the second explanatory model to a second classification data point output by the machine learning model based on a second set of transaction data.

### BACKGROUND

Artificial intelligence technology today is advancing at a breakneck pace. However, despite the ever-growing achievements and advancement of deep learning and machine learning models, it is difficult to leverage complex tree-based models or deep learning models because, for example, the reasoning behind many artificial intelligence systems decisions can be difficult to interpret. Apart from the noisy and highly imbalanced data challenges faced when using many machine learning models, recent regulations, such as the ‘right to explanation’ introduced by the General Data Protection Regulation (GDPR) and the Equal Credit Opportunity Act (ECOA), have added the need for model interpretability to ensure that algorithmic decisions are understandable, accurate, and coherent.

### BRIEF DESCRIPTION OF THE DRAWINGS

FIG. 1 illustrates an example system for explanatory model evaluation and selection, in accordance with an implementation;

FIG. 2 illustrates an example method for explanatory model evaluation and selection, in accordance with an implementation;

FIG. 3 illustrates a sequence diagram for explanatory model evaluation and selection, in accordance with an implementation;

FIG. 4 illustrates an example sequence for machine learning model generation, in accordance with an implementation;

FIG. 5 illustrates an example sequence for explanatory model evaluation and selection, in accordance with an implementation;

FIG. 6 discloses a computing environment in which aspects of the present disclosure may be implemented, in accordance with an implementation; and

FIG. 7 illustrates an example machine learning framework that techniques described herein may benefit from.

### DETAILED DESCRIPTION

As mentioned above, despite the ever-growing achievements and advancement of deep learning and machine learning models, it is difficult to leverage complex tree-based models or deep learning models, particularly for sensitive determinations such as for credit scoring or other transaction-based determinations. When using artificial intelligence with sensitive information (e.g., personally identifiable information (PII)) or to make sensitive decisions, such as to determine a credit score or whether to approve a loan, it is important to be able to provide the reasoning behind the decisions. However, one of the biggest obstacles in most artificial intelligence systems is their lack of interpretability. Many artificial intelligence systems operate as a black box without indicating why they made their decisions. Regulators have attempted to force companies to provide reasoning behind decisions with recent regulations such as the ‘right to explanation’ introduced by the GDPR and the ECOA. However, it is difficult for companies to comply with these regulations given the complex and technical nature of trained machine learning models.

Attempts to generate explanations can include using explanatory models that are configured to identify the impact of different features on a particular prediction as explanations for the prediction. However, even these explanatory models have shortcomings. For example, such explanatory models may provide unstable explanations and diverge from their promised theoretical properties. There is a need to not only have standard explainability frameworks, but also have standard and unbiased evaluation procedures for generating machine learning model prediction explanations. An explanatory model can be an explainable artificial intelligence model.

A computer implementing the systems and methods described herein can overcome the aforementioned technical deficiencies by selectively using individual explanatory models to generate explanations for machine learning model outputs to accurately and precisely generate explanations for outputs of a machine learning model. For example, the computer can use an explanatory model selection policy that includes one or more rules that each correspond to a set of explanatory models to use to explain a machine learning model decision if the rule were to be satisfied. For instance, the computer can train a machine learning model to generate classification predictions based on transaction data. An example of such a machine learning model is a model trained to predict whether to accept an application for a loan or to determine a credit score for an account based on transactions the account has performed within a defined time period. The computer can execute the machine learning model using a set of transaction data. The machine learning model can generate an output classification data point based on the execution. The computer can then apply a first explanatory model (e.g., a game theory-based model, such as a Shapley Additive exPlanations (SHAP) model or a Kernel SHAP model) to the classification data point and generate metrics (e.g., explainability metrics, such as a prescriptivity metric, a local fidelity metric, a local concordance metric, and/or a reiteration similarity metric) for the first explanatory model based on the application. The computer can compare the metrics to different thresholds or rules of the explanatory model selection policy. Responsive to determining the metrics satisfy a rule indicating to add or otherwise use a second explanatory model (e.g., a perturbation-based model, such as a Local Interpretable Model-Agnostic Explanations (LIME) model, a Deterministic Local Interpretable Model-Agnostic Explanations (D-LIME) model, or saliency techniques (e.g., SmoothGrad, Vanilla Gradients, Guided Back propagation, Integrated Gradients, Grad—CAM), the computer can perform the same analysis with the two explanatory models in combination or just the second explanatory model to generate new metrics, depending on the rule of the explanatory model selection policy that was satisfied.

The computer can determine whether the newly generated metric satisfy the explanatory model selection policy. For example, the computer can compare the metrics generated for the combination of the second explanatory model and the first explanatory model or just the second explanatory model to one or more thresholds. Responsive to determining a value of one of the metrics is below or otherwise does not satisfy a threshold, the computer may select an explanatory model to provide an explanation or reconfigure the machine learning model, such as by configuring the machine learning model to accept different types of features to generate a classification output or to adjust the number of layers (e.g., hidden layers of a neural network) or nodes that are in the model.

Advantageously, using the above-described method of explanatory model selection and processing, the computer can provide an improved method of machine learning interpretability as well as machine learning reconfiguration. The methods can be used to select explanatory models to use for the analysis in real time for different data points, in some cases taking the type of prediction that is being taken into account for the explanatory model selection. These methods can facilitate versatile and adaptive machine learning processes for greater data prediction and interpretation.

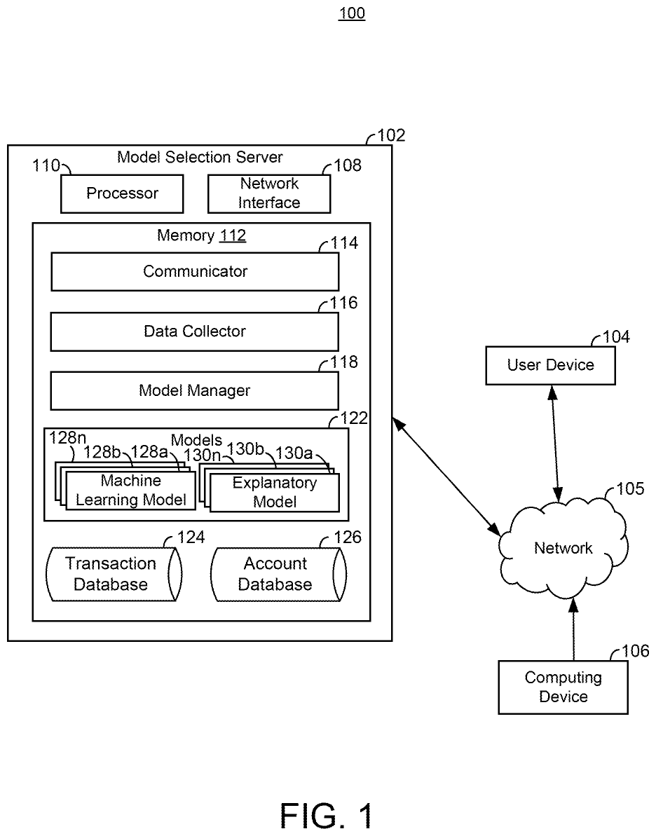

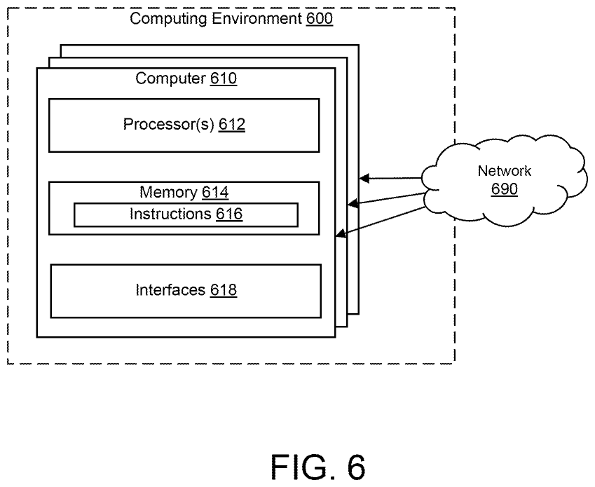

For example, FIG. 1 illustrates an example system 100 for explanatory model evaluation and selection, in accordance with an implementation. In brief overview, the system 100 can include a model selection server 102, a user device 104, and/or a computing device 106. The model selection server 102, the user device 104, and/or the computing device 106 can each include one or more aspects or features described elsewhere herein, such as in reference to the computing environment 600 of FIG. 6. The model selection server 102 can be configured to generate and/or use one or more machine learning models to generate predictions (e.g., classification predictions) based on transaction data. The model selection server 102 may evaluate predictions made by a machine learning model using different explanatory models according to an explanatory model selection policy. The model selection server 102 can execute the machine learning model based on a new set of transaction data to generate a classification prediction. The model selection server 102 can apply a selected explanatory model to the classification prediction to generate an explanation of the classification prediction. In this way, the model selection server 102 can navigate the black box of a machine learning model to generate an accurate and precise explanation of a classification prediction made by the machine learning model. The system 100 may include more, fewer, or different components than shown in FIG. 1.

The model selection server 102, the user device 104, and/or the computing device 106 can include or execute on one or more processors or computing devices and/or communicate via a network 105. The network 105 can include computer networks such as the Internet, local, wide, metro, or other area networks, intranets, satellite networks, and other communication networks, such as voice or data mobile telephone networks. The network 105 can be used to access information resources such as web pages, websites, domain names, or uniform resource locators that can be presented, output, rendered, or displayed on at least one computing device (e.g., the model selection server 102, the user device 104, and/or the computing device 106), such as a laptop, desktop, tablet, personal digital assistant, smartphone, portable computer, or speaker.

The model selection server 102, the user device 104, and/or the computing device 106 can include (e.g., each include) or utilize at least one processing unit or other logic devices such as a programmable logic array engine or a module configured to communicate with one another or other resources or databases. As described herein, computers can be described as computers, computing devices, user devices, or client devices. The model selection server 102, the user device 104, and/or the computing device 106 may each contain a processor and a memory. The components of the model selection server 102, the user device 104, and/or the computing device 106 can be separate components or a single component. The system 100 and its components can include hardware elements, such as one or more processors, logic devices, or circuits.

The computing device 106 can be a point-of-sale device (e.g., a point-of-sale computing device). For example, the computing device 106 can include a register at a brick-and-mortar store or a server in the cloud that facilitates transactions for online stores. The computing device 106 can be configured to receive a request for an item purchase in a transaction. The computing device 106 can identify attributes of the items (e.g., value, item type, number of items, etc.) and/or other attributes of the transaction (e.g., time of the transaction, geographical location of the transaction, type of the transaction (e.g., online or at a brick-and-mortar store), total value of the transaction, etc.) and transmit the attributes of the transaction and/or an identifier of a profile or account (e.g., an identifier of a transaction card that was used to initiate the transaction) to the model selection server 102 or another computer of the institution that manages the model selection server 102 in a transaction request.

The user device 104 can be an electronic computing device (e.g., a cellular phone, a laptop, a tablet, or any other type of computing device). The user device 104 can include a display with a microphone, a speaker, a keyboard, a touchscreen, or any other type of input/output device. A user can access a platform provided by the model selection server 102 through the user device 104 to view outputs of machine learning models and/or otherwise manage an account the user has with an institution (e.g., a financial institution) that owns or manages the model selection server 102. In one example, users can request a credit score or request a loan from the financial institution. The model selection server 102 may receive such requests and generate responses to the requests, such as by using one or more machine learning models. The model selection server 102 may generate the responses prior to receiving the requests (e.g., generate a credit score for a user at a set interval and transmit the most recently generated credit score to the user in response to receipt of the request) or in response to receiving the requests (e.g., generate an acceptance or a decline of a request for a loan in response to the request). The model selection server 102 can transmit the responses back to the user device 104 over the network 105.

The model selection server 102 may comprise one or more processors that are configured to evaluate different explanatory models to use to generate explanations for individual machine learning models. The model selection server 102 may comprise a network interface 108, a processor 110, and/or memory 112. The model selection server 102 may communicate with the user device 104 and/or the computing device 106 via the network interface 108, which may be or include an antenna or other network device that enables communication across a network and/or with other devices. The processor 110 may be or include an ASIC, one or more FPGAs, a DSP, circuits containing one or more processing components, circuitry for supporting a microprocessor, a group of processing components, or other suitable electronic processing components. In some embodiments, the processor 110 may execute computer code or modules (e.g., executable code, object code, source code, script code, machine code, etc.) stored in memory 112 to facilitate the activities described herein. The memory 112 may be any volatile or non-volatile computer-readable storage medium capable of storing data or computer code.

The memory 112 may include a communicator 114, a data collector 116, a model manager 118, models 122, a transaction database 124, and/or an account database. In brief overview, the components 114-122 may generate one or more machine learning models that are configured to generate outputs (e.g., classification outputs) based on transaction data. The components 114-122 can execute a machine learning model to generate a classification data point. The components 114-122 can execute different combinations of explanatory models to generate explanations for the classification data point. The components 114-122 can evaluate the different explanations by determining metrics for the combinations of the explanatory models and selecting a combination of explanatory models with metrics that satisfy an explanatory model selection policy (e.g., one or more rules of an explanatory model selection policy). The components 114-122 can generate an explanation for a classification data point subsequently generated by the machine learning model using the selected combination of explanatory models. The components 114-122 can transmit the explanation to a computing device that initially transmitted a request that caused the execution of the machine learning model. In this way, the components 114-122 can provide an accurate analysis or description of the reasoning behind an output of the machine learning model.

The communicator 114 may comprise programmable instructions that, upon execution, cause the processor 110 to communicate with the user device 104, the computing device 106, and/or any other computing device. The communicator 114 can be or include an application programming interface (API) that facilitates communication between the model selection server 102 (e.g., via the network interface 108 of the model selection server 102) and other computing devices. The communicator 114 may communicate with the user device 104, the computing device 106, and/or any other computing devices across a network (e.g., the network 105).

In one example, the communicator 114 can establish a connection with a computing device (e.g., the user device 104 or the computing device 106). The communicator 114 can establish the connection with the computing device over the network 105. To do so, the communicator 114 can communicate with the computing device across the network 105. In one example, the communicator 114 can transmit a syn packet to the computing device 106 (or vice versa) and establish the connection using a TLS handshaking protocol. The communicator 114 can use any handshaking protocol to establish a connection with the computing device 106. The model selection server 102 can communicate with the computing device 106 over the established connection.

The data collector 116 may comprise programmable instructions that, upon execution, cause the processor 110 to collect data regarding accounts and/or transactions performed through different accounts. The data collector 116 can collect data regarding accounts when users participate in an enrollment period with the model selection server 102 or another server owned by the institution that owns or manages the model selection server 102. For example, a user may sign up with a platform that the model selection server 102 provides to manage the user's finances and/or transactions. For instance, a user may sign up to have a profile (e.g., an account) with a checking account, a savings account, and/or a credit card account that includes different variations of financial information for the user. The model selection server 102 can generate such accounts for different individuals as the individuals enroll to access the platform. In generating the accounts, the model selection server 102 can receive information (e.g., demographic information) for the accounts from the enrolling users. The model selection server 102 can generate account identifiers or numbers for the respective accounts. The model selection server 102 can store such account information in the account database 126.

The account database 126 can be or include a relational or graphical database configured to store data (e.g., account data) for different accounts. The account database 126 can store records (e.g., tables or data structures) for each account that includes data for the account. The account database 126 can also include linkages between the accounts that belong or correspond to the same individual or organization. Each record can include one or more field-value pairs that each correspond to a different type of data.

The data collector 116 can store transaction data generated from different transactions in the transaction database 124. The data collector 116 can store transaction data performed by accounts of the account database 126 in the transaction database 124. For example, the data collector 116 can receive (e.g., via the communicator 114) transaction data of a transaction that has successfully completed or that is in the process of being completed by accounts of the account database 126 from different computing devices (e.g., point-of-sale devices). The transaction data can include various data of the transactions, such as an amount, an MC code, a location, a number of items purchased, a time, etc. The data collector 116 can receive the transaction data for the transactions and store the transaction data in the transaction database 124, in some cases as separate records for each transaction and/or with identifiers of the accounts that were used to perform the transactions.

The transaction database 124 can be or include a relational database or a graphical database. The transaction database 124 can include transaction data for transactions performed by different accounts (e.g., transactions performed by entities associated with the accounts). The accounts can be accounts associated with or managed by the institution that owns or manages the model selection server 102, for example. The accounts can correspond with transactions or store currency data of or for individual users. The transaction data can include, for individual transactions performed through the accounts, a transaction amount (e.g., a value or a transaction value), a timestamp indicating the time in which the transaction was performed or completed, identifications of the accounts participating in the transaction, the location of the transaction, and/or any other data regarding the transactions. The transaction database 124 can store the transaction data in records and/or data structures (e.g., tables).

The model selection server 102 can store data for transactions in the transaction database 124 over time. For example, the model selection server 102 can receive transaction data from the computers and/or servers that manage or otherwise facilitate the transactions as the transactions are processed and/or completed. Responsive to receiving the transaction data, the model selection server 102 can store the transaction data in the transaction database 124 in records for the individual transactions. The model selection server 102 can store the records in the data structures within the transaction database 124 for the accounts participating in the transactions. The model selection server 102 can generate and store such records for transactions as the model selection server 102 receives transaction data for the transactions over time.

The model manager 118 can comprise programmable instructions that, upon execution, cause the processor 110 to generate, select, and/or use the models 122 to generate predictions based on transaction data and explanations of how or why the predictions were generated. For example, the model manager 118 can generate machine learning models 128a-n (together machine learning models 128 and individually machine learning model 128). The machine learning models 128a-n may each be a machine learning model (e.g., a neural network, a support vector machine, a random forest, a gradient boosting model, etc.) configured to generate predictions based on different inputs, such as input transaction data. The machine learning models 128a-n may be configured to generate predictions such as a credit score, whether to approve a loan, whether to accept a transaction, whether to issue a new card, etc. The machine learning models 128a-n may include any number of machine learning models.

The model manager 118 can train the machine learning models 128. The model manager 118 may do so using supervised, semi-supervised, or unsupervised learning techniques. For example, the model manager 118 can use supervised learning to train a machine learning model 128 using a labeled training dataset. For instance, to train a machine learning model 128 to make loan approval determinations, the model manager 118 can retrieve data from the transaction database 124 for a number of transactions performed by an account within a defined time period (e.g., the previous year). The model manager 118 can determine whether a loan was approved for the account from data for the account in the account database 126 indicating an accepted or rejected loan within another defined time period (e.g., within the past 3 weeks). In some cases, this training may be triggered upon an approval or rejection of a loan. The model manager 118 can label the retrieved transaction data for the account with the indication of whether the loan was approved or not and input the transaction data into the machine learning model 128. In some cases, the model manager 118 can label the transaction data based on a user input. The model manager 118 can execute the machine learning model 128 to generate an approval or disapproval prediction. The model manager 118 can use backpropagation techniques to adjust internal weights and/or parameters of the machine learning model 128 based on a difference between the prediction and the label. The model manager 118 can repeat this process any number of times with any number of training datasets to train the machine learning model 128 to make loan approval determinations. The model manager 118 can continue the process until determining the machine learning model 128 is accurate to a threshold, at which point the model manager 118 can deploy the machine learning model 128 to make predictions based on real-world or real-time transaction data. The model manager 118 can similarly train any number of machine learning models 128 to generate predictions of any type.

The model manager 118 can use explanatory models 130a-n (together explanatory models 130 and individually explanatory model 130) to generate explanations for outputs of the machine learning models 128. For example, the explanatory models 130 can include a SHAP model and/or a LIME model or a saliency method. Saliency methods (often referred to as feature attribution methods) are techniques for explaining a machine learning model's decision. Given an input, model, and target label, saliency methods compute a feature-wise importance score describing each feature's influence on the model's output for the target label. The SHAP model can have a game theory foundation based on the concept of Shapley values from cooperative game theory, which allocates the payout (e.g., prediction) among the players (e.g., features) based on their contribution to the total payout. The SHAP model can determine feature contributions to an output of a machine learning model in which the SHAP model calculates the contribution of each feature to the prediction of each instance, considering different (e.g., all) possible combinations of features. The SHAP model can provide both global insights, which explain model behavior in general, and local explanations, which detail how the model makes predictions for individual instances.

The explanatory models 130 can additionally or instead include a LIME model. The LIME model can be configured to generate explanations for the predictions of a machine learning model in an interpretable and faithful manner by approximating the machine learning model locally with an interpretable model. The LIME model can be configured to perturb input data and observe changes in predictions based on the perturbed input data. By creating a new dataset of perturbed samples and the corresponding predictions, the LIME model can train an interpretable model, such as a linear model or decision tree, on the new dataset. The explanatory models 130 can be configured to make predictions of machine learning models understandable to humans by breaking down the predictions into understandable contributions from each input feature. The explanatory models 130 can be configured to be operable with any type of machine learning model. The explanatory models 130 can include any number of explanatory models of any type.

The model manager 118 can determine which explanatory model or explanatory models to use to generate explanations for outputs by a machine learning model 128 (e.g., a gradient boosting model or any other type of machine learning model). The model manager 118 can do so after generating or training or retraining the machine learning model 128. For example, responsive to training a machine learning model 128 to generate classification outputs (e.g., a credit score or a lending decision) the model manager 118 can determine which explanatory models 130 to use to generate explanations for outputs by the machine learning model 128. To do so, the model manager 118 can generate an input of transaction data from an account with a defined time period (e.g., the same defined time based on which the machine learning model 128 was trained). The model manager 118 can input the transaction data into the machine learning model 128 and execute the machine learning model 128. Based on the execution, the machine learning model 128 can output a classification data point (e.g., a first classification data point) or value (e.g., an indication to provide a loan or a credit score). The model manager 118 can apply a SHAP model (or any other game theory-based explanatory model or explanatory model, for example) of the explanatory models 130 to the classification data point to generate an explanation (e.g., a first explanation) for the classification data point.

The explanation can include one or more SHAP values (e.g., numerical values). The SHAP values can indicate a contribution of individual features for generating the classification data point. The SHAP values can include a magnitude indicating the strength of the impact and a sign (e.g., positive or negative) indicating the direction of the impact. A positive SHAP value can mean that the feature pushed the model's prediction higher, while a negative value can indicate that the feature pushed the model's prediction lower. The SHAP model can generate such SHAP values for the individual features that were input into the machine learning model 128 to generate the classification data point.

The model manager 118 can generate explanation evaluation metrics for the SHAP model. The model manager 118 can generate the metrics for the SHAP model based on the first classification data point or the execution of the machine learning model 128 that caused the machine learning model 128 to generate the first classification data point. The metrics can be or include one or more of a prescriptivity metric, a local fidelity metric, a local concordance metric, and/or a reiteration similarity metric.

Local fidelity can measure the accuracy of an approximation model (e.g., a white box model) in approximating behavior of a black box model for a target sample x around x's synthetic neighborhood. Being a local metric, different samples will result in different local fidelity scores. By using the neighborhood N(x) instead of x, local fidelity can provide an indication of how an approximation model behaves in the locality of x, but therefore local fidelity can be dependent on how the N(x) points are sampled.

The model manager 118 can determine a local fidelity metric (e.g., a value for the local fidelity metric) for the SHAP model based on the classification data point output by the machine learning model 128. To do so, the model manager 118 may first compute the SHAP values for the classification data point, detailing the contribution of each input feature towards the model's output. The model manager 118 can calculate the expected value, which can be the average model output over a dataset of predictions by the machine learning model 128. The expected value can be a baseline for determining the local fidelity metric. The model manager 118 can sum or aggregate the SHAP values for all features for the classification data point and add this sum or aggregate value to the expected value to construct or generate a SHAP-based prediction. The model manager 118 can compare the SHAP-based prediction to the original model prediction for the classification data point to assess the local fidelity. A close match can indicate a high local fidelity, confirming that the SHAP values effectively represent the model's decision-making process for the specific instance.

Local concordance can measure the accuracy of an approximation model in mimicking a black box model for a single instance x under a conciseness constraint. Local concordance can be calculated using the hinge loss function such that the score ranges from 0 for total disagreement to 1 for a perfect match.

The model manager 118 can determine a local concordance metric (e.g., a value for the local concordance metric) for the SHAP model based on the classification data point output by the machine learning model 128. To do so, the model manager 118 may first identify a subset of predictions from a dataset of predictions by the machine learning model 128 that share similar feature values or fall within a specific region of interest. The model manager 118 can calculate SHAP values for these selected instances to understand the contribution of each feature towards the machine learning model 128's predictions within this local subset. The model manager 118 can analyze the consistency of feature contributions across these instances such as by determining a correlation coefficient for SHAP values of each feature across instances in which a high correlation indicates a consistent feature contribution and/or by determining a coefficient of variation of each feature relative to the average SHAP value of the feature across the instances. A lower variability can indicate a higher consistency. The correlation coefficient can be the concordance metric or the opposite of the coefficient of variation.

Prescriptivity measures how effective an approximation model is when taken as a recipe to change the predicted class of the sample data x. The model manager 118 can determine a prescriptivity metric (e.g., a value for the prescriptivity metric) for the SHAP model based on the classification data point output by the machine learning model 128. To do so, the model manager 118 can identify the classification data point output by the machine learning model 128. The model manager 118 can modify one or more actionable features of input transaction data that resulted in the classification data point. The model manager 118 can execute the machine learning model 128 again based on the modified input transaction data to generate a revised classification data point. The model manager 118 can determine the prescriptivity metric for the SHAP model based on the difference between the revised classification data point and the initial classification data point.

Reiteration similarity can measure the similarity of a set of explanations of a single instance x as a measure of similarity across multiple reiterations of the explanation process. To be trusted, an explanation needs to be stable. For example, the explainability method should not provide entirely different sets of relevant features if called multiple times to explain the same instance x. Reiteration similarity can be a precondition that needs to be verified.

The model manager 118 can determine a reiteration similarity metric (e.g., a value for the reiteration metric) for the SHAP model based on the classification data point output by the machine learning model 128. To do so, the model manager 118 may identify repeated or similar instances of inputs into the machine learning model 128 that caused the machine learning model to generate an output. The model manager 118 can identify the repeated or similar instances by selecting pairs or groups of instances that are either identical or have high similarity based on selected features. Similarity can be determined using metrics such as Euclidean distance, cosine similarity, or other domain-specific measures for comparing instances. The model manager 118 can calculate predictions and SHAP values for each identified instance or group. The model manager 118 can calculate a consistency metric for predictions across the repeated or similar instances, such as by calculating the standard deviation, variance, or another statistical measure of spread for the predictions. The model manager 118 can calculate, for each feature, the similarity of SHAP values across the identified instances. Doing so can involve determining metrics like Pearson correlation for continuous features or Jaccard similarity for categorical features, to quantify how consistently each feature contributes to the model's output across similar instances. The model manager 118 can determine a reiteration similarity metric by calculating an average of the SHAP values across all of the features across one or more or all of the instances.

The model manager 118 can apply an explanatory model selection policy to the metrics that the model manager 118 determines for the SHAP model based on the classification data point output by the machine learning model. The explanatory model selection policy can be or include one or more rules that each correspond to a different set of explanatory models 130 to apply to a machine learning model 128 to generate explanations of outputs by the machine learning model 128. The rules of the ensemble explanatory model selection policy can each include one or more thresholds that correspond to the different types of metrics (e.g., the prescriptivity metric, the local fidelity metric, the local concordance metric, and/or the reiteration similarity metric). For example, a rule can include a separate threshold for a combination or permutation of each of the prescriptivity metric, the local fidelity metric, the local concordance metric, and/or the reiteration similarity metric. The rule can be satisfied if at least one of the metrics for the SHAP model generated based on the classification data point are below the corresponding thresholds. The different rules can be satisfied based on different metrics failing and/or succeeding the corresponding thresholds of the rules as defined in the respective rules.

In one example, the explanatory model selection policy can include a threshold of 0.4 for each of the prescriptivity metric, the local fidelity metric, the local concordance metric, and/or the reiteration similarity metric. The model manager 118 can compare the metrics determined for the SHAP model based on the classification data point to the thresholds. The model manager 118 can determine the rule is satisfied if each of the metrics exceeds 0.4. In some cases, the rule can be configured such that the model manager 118 determines the rules is satisfied if at least one of or a defined number of the metrics is less than 0.4.

In some cases, the model manager 118 can determine a set of explanatory models 130 to use to generate explanations for the machine learning models 128 based on a rule of the explanatory model selection policy that is satisfied. For example, each rule of the explanatory model selection policy can correspond to a different set of explanatory models 130. The sets of explanatory models 130 can include different permutations or combinations of explanatory models 130. For example, one set of explanatory models 130 may only include the SHAP model. Another set of explanatory models 130 may only include the LIME model. Another set of explanatory models 130 may include both the SHAP model and the LIME model. Another set of explanatory models 130 may include a different game theory or perturbation-based model. The model manager 118 can apply the rules of the explanatory model selection policy to the metrics for the SHAP model generated based on the classification data point output by the machine learning model 128 and identify a rule that is satisfied by the metrics. The model manager 118 can identify the set of explanatory models 130 that corresponds with the satisfied rule to use to generate explanations for classification data points that are later generated by the machine learning model 128.

In some embodiments, the model manager 118 can determine metrics (e.g., prescriptivity metrics, the local fidelity metrics, the local concordance metrics, and/or reiteration similarity metrics) for other explanatory models 130 based on the classification data point. For example, the model manager 118 can determine metrics for the LIME model and any other models of the explanatory models 130 based on (e.g., based at least on) the classification data point generated by the machine learning model 128. The model manager 118 can compare the metrics determined for the different explanatory models 130 to the different rules of the explanatory model selection policy to identify a rule that is satisfied by the explanatory evaluation metrics. The model manager 118 can identify a rule that is satisfied by the metrics and identify the set of explanatory models to use to generate explanations for outputs generated by the machine learning model 128.

In some embodiments, the model manager 118 can sequentially determine metrics for the different explanatory models 130. For example, the model manager 118 can determine metrics for the SHAP model of the explanatory models 130 based on the classification data point. The model manager 118 can compare the metrics to corresponding thresholds for the metrics. Responsive to determining at least one of the metrics is less than the corresponding threshold for the metric, the model manager 118 can identify the LIME model from the explanatory models 130. The model manager 118 can apply both the LIME model and the SHAP model to the classification data point to generate metrics (e.g., second metrics or new metrics) for the combination of the LIME model and the SHAP model. The model manager 118 can compare the newly generated metrics to corresponding thresholds (e.g., threshold for the respective metrics). The thresholds can the same or different between each other. In some cases, the model manager 118 may only compare the local fidelity and local concordance metrics to thresholds. Responsive to determining each of the compared metrics exceeds or otherwise satisfies the corresponding thresholds, the model manager 118 may determine to use the LIME model and the SHAP model together to generate predictions for the machine learning model 128.

In some embodiments, the model manager 118 can generate an average or sum of the metrics to determine a rule of the explanatory model selection policy is satisfied. For example, the model manager 118 can aggregate the metrics that the model manager 118 generated for the SHAP model into a score. In some cases, the model manager 118 can weight the metrics based on defined weights to generate the score as a weighted sum or average to compare to the explanatory model selection policy. The weights can always be the same or can vary based on a machine learning model type (e.g., neural network, gradient boosting, random forest, etc.) of the machine learning model that will be evaluated, a type of the output (e.g., loan approval, credit score, etc.), etc., or some combination of such factors. The model manager 118 can compare the score to the rules of the explanatory model selection policy to determine which of the rules of the explanatory model selection policy is satisfied.

Responsive to determining the set of explanatory models 130 to use to generate explanations for the machine learning model 128, the model manager 118 can use the determined set of explanatory models 130 to generate explanations based on subsequent outputs by the machine learning model 128. For example, the model selection server 102 can receive a request for a credit score for an account from the user device 104. Responsive to receiving the request, the model manager 118 can generate a feature vector of transaction data for the account and/or account data of the account and identify the machine learning model 128 configured to generate credit scores. The model manager 118 can execute the machine learning model 128 using the feature vector as input. The machine learning model 128 can output a classification data point (e.g., second classification data point), such as a credit score for the account, based on the execution. The model manager 118 can apply the determined set of explanatory models 130 to the classification data point to generate an explanation for the classification data point. The communicator 114 can generate a record including the classification data point as well as the explanation for the classification data point and transmit the record to the user device 104. The user device 104 can display the classification data point and the explanation on a user interface. The model selection server 102 can similarly select and use sets of explanatory models 130 for any number of machine learning models.

In one example of using metrics and rules to select a set of explanatory models 130 to use to generate explanations for a machine learning model 128, the model manager 118 can implement the following rules. If three or all of our metrics are greater than a threshold (e.g., 0.4) then the model manager 118 can select the SHAP model alone to generate explanations for the machine learning model 128. For instance, the model manager 118 may select the SHAP model based on the SHAP model having a high a value (e.g., a value above a threshold) for the prescriptivity, local concordance and reiteration metrics and only a low value (e.g., a value below a threshold or the same threshold) for local fidelity. However, if the machine learning model 128 is configured to generate decisions for credit score, the model manager 118 may only select the SHAP model only if the SHAP model is determined to have a high fidelity score as well. Different types of decisions can correspond to different rules in any manner.

Another rule of the explanatory model selection policy can be based on the local concordance metric. For instance, responsive to determining the SHAP model has a local concordance below a threshold (e.g., below 0.4), the model manager 118 can check whether the reiteration similarity is below a threshold. If both scores are low (e.g., below a threshold), the model manager 118 can add a perturbation, counterfactual, or saliency-based model and reperform the analysis (e.g., generate metrics with the new model added and apply the explanatory model selection policy to the new metrics) because a low concordance metric and a low reiteration similarity metric can indicate that the SHAP model is not successfully able to replicate the machine learning model 128's behavior.

Another rule of the explanatory model selection policy can be based on the reiteration similarity metric. For example, responsive to determining the SHAP model has a reiteration similarity score below a threshold (e.g., 0.4), the model manager 118 can determine whether the local concordance of the SHAP model is also below a threshold (e.g., 0.4). Responsive to determining both the reiteration similarity score and the local concordance of the SHAP model are below a threshold, the model manager 118 can add a perturbation or counterfactual or saliency-based approach to reperform the analysis.

Another rule of the explanatory model selection policy can be based on the local fidelity metric. For example, responsive to determining the SHAP model has a local fidelity metric below a threshold (e.g., 0.4), the model manager 118 can add a perturbation-based model (e.g., LIME or D-LIME) and reperform the analysis. Adding perturbation based models such as LIME or DLIME can elevate the local fidelity score. Therefore, our final inference is to go in for an ensemble explainability technique using combination of game theory and perturbation method. A low local fidelity can indicate an explanatory model is not performant in approximating the behavior of the machine learning model 128 for a test sample around its synthetic neighborhood. The local fidelity metric can be a strong indicator of performance of an explanatory model for a credit scoring model, for example.

However, if the local fidelity score remains low after adding the perturbation-based model, the model manager 118 can reassess the experiment (e.g., perform the explanatory model selection process again) with a different machine learning model (e.g., a linear classifier) configured to generate classification outputs of the same type. If the machine learning model 128 was a neural network or a multilayer perceptron (MLP) model, the model manager 118 can change the type of machine learning model to use to generate classifications of the same type and check the distribution graphs for any non-linearity or outliers.

Another rule of the explanatory model selection policy can be based on the prescriptivity metric. For example, responsive to determining the SHAP model has a prescriptivity metric below a threshold (e.g., 0.4), the model manager 118 can the model manager 118 can add a perturbation-based model (e.g., LIME or D-LIME) and reperform the analysis. A low prescriptivity can indicates that the list of features and feature ranking provided by the SHAP model technique are not indicative enough to change the prediction of a data point from class A to class B. A high prescriptivity showcases that the explanation can be trusted proactively.

Another rule of the explanatory model selection policy can indicate not to use a game theory-based model or another type for model. For example, responsive to determining each metric for an explanatory model 130 is below a threshold, the model manager 118 can determine not to use the explanatory model 130 and select a different explanatory model 130 or determine metrics for another explanatory model 130 to determine whether to use that explanatory model 130.

The model manager 118 can perform the explanatory model selection process upon determining an event occurred. For example, the model manager 118 can initiate the explanatory model selection process can reperform the process for a machine learning model 128 each instance the machine learning model 128 is trained, which may occur at set intervals, randomly, or based upon a request. Doing so may be useful because an adjustment in weights and/or parameters of a machine learning model may cause a different explanatory model to be more accurate than prior to the adjustment. In another example, the model manager 118 can initiate the explanatory model selection process in response to receipt of a request or at set intervals. The model manager 118 can perform the process responsive to any event occurring or detecting any event occurred.

The model manager 118 can perform the model selection process separately for different machine learning models 128. For example, the model manager 118 can select different sets of explanatory models to use to generate explanations for different machine learning models 128. Such may be beneficial because different explanatory models 130 and/or combinations of explanatory models 130 can be more accurate (e.g., have higher metrics) for different types of machine learning models 128 (e.g., neural networks, gradient boosting models, random forest, etc.) and/or different types of outputs (e.g., credit scoring, loan approval, etc.). The model manager 118 can store indications in memory of the sets of explanatory models 130 to use to generate explanations for the different machine learning models 128.

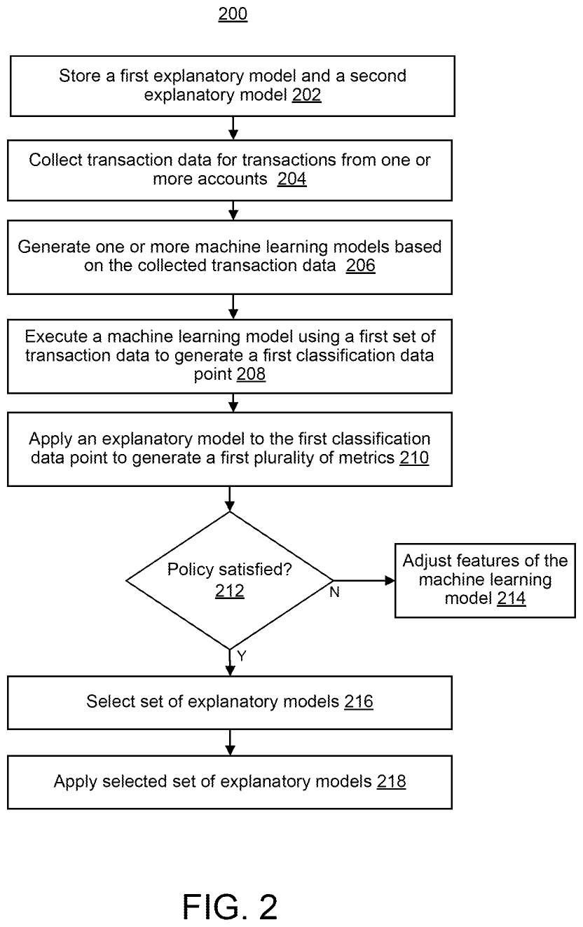

FIG. 2 illustrates an example method 200 for explanatory model evaluation and selection, in accordance with an implementation. The method 200 can be performed by a data processing system (e.g., the model selection server 102, the user device 104, and/or the computing device 106, each shown and described with reference to FIG. 1, a server system, etc.). The method 200 may include more or fewer operations and the operations may be performed in any order. Performance of the method 200 may enable the data processing system to selectively evaluate and select explanatory models to use to generate (e.g., automatically generate) explanations for machine learning model outputs. The method 200 may enable the data processing system to do so to increase the accuracy of explanations for machine learning model outputs, which are typically black boxes and difficult to decipher.

In the method 200, at operation 202, the data processing system stores a first explanatory model and a second explanatory model. The first explanatory model can be a game theory-based explanatory model, such as a SHAP model or a kernel SHAP model, and the second explanatory model can be a perturbation-based model, such as a LIME model or a D-LIME model, in some embodiments. The data processing system can store the first explanatory model and the second explanatory model in memory or in a database. The data processing system can store any number of explanatory models of any type in memory. In some embodiments, the first explanatory model is a perturbation-based model and the second explanatory model is a game theory-based model.

At operation 204, the data processing system collects transaction data for transactions from one or more accounts. The transaction data can be data of transactions (e.g., purchases or currency transfers) performed by the one or more accounts. The transaction data can include an amount, a timestamp, an MC code, a date, etc., for individual transactions. The data processing system can collect the transaction data by receiving the transaction data from one or more computers that perform the transactions and/or by playing a role in completing the transactions. For example, the data processing system can include one or more computing devices that are configured to approve transactions and/or manage accounts through which transactions are completed. The data processing system can store the transaction data for such transactions in memory as the data processing system completes the transactions. Otherwise, the data processing system may collect the transaction data from different computers that are a part of a sequence of computers that operate to complete the transactions.

At operation 206, the data processing system generates one or more machine learning models. The data processing system may generate the one or more machine learning models based on the collected transaction data. For example, the data processing system may retrieve the transaction data of one or more transactions from memory. The data processing system may retrieve the transaction data by retrieving the transaction data from a defined time period. The data processing system may train different machine learning models to generate outputs (e.g., classification outputs), such as a loan approval or a credit score, using a supervised training method. For example, the data processing system may generate training datasets for the machine learning models using the retrieved transaction data by labeling the retrieved transaction data for separate accounts with the correct outputs. The data processing system may input the training datasets into the machine learning models and train the respective machine learning models based on differences between the labels for the training datasets and the outputs of the machine learning models. The data processing system may train the machine learning models in this way until determining the respective machine learning models are accurate to an accuracy threshold. Responsive to determining the machine learning models are accurate to an accuracy threshold, the data processing system can deploy (e.g., use for real-time predictions) the machine learning models and store the machine learning models in memory.

At operation 208, the data processing system executes a machine learning model. The data processing system can execute the machine learning model using a first set of transaction data. The data processing system can execute the machine learning model in response to receiving a request from a client device. For example, the data processing system can receive a request to generate a credit score for an account from a client device. In response to receiving the request, the data processing system can identify the machine learning model from different machine learning models stored in memory based on the machine learning model corresponding to generating credit scores. The data processing system can retrieve transaction data for the account based on an identifier of the account in the request. The data processing system can generate a feature vector from the retrieved transaction and input the feature vector into the machine learning model. The data processing system can execute the machine learning model with the feature vector as input to generate a first classification data point (e.g., a credit score).

At operation 210, the data processing system applies an explanatory model to the first classification data point. The data processing system can apply the first explanatory model (e.g., the SHAP model) to the first classification data point. In doing so, the data processing system can generate or determine a plurality of metrics (e.g., a prescriptivity metric, a local fidelity metric, a local concordance metric, and/or a reiteration similarity metric) for the first explanatory model. The data processing system can determine any number of metrics for the first explanatory model.

At operation 212, the data processing system determines whether an explanatory model selection policy is satisfied. The explanatory model selection policy can be or include one or more rules that each correspond to a different set of explanatory models. For example, one rule can correspond to only the first explanatory model, another rule can correspond to only the second explanatory model, and/or another rule can correspond to both the first explanatory model and the second explanatory model. The rules can be or include thresholds and/or ranges for the different metrics and/or rules including selection criteria for a sum or aggregate of the different metrics. In one example, a rule of the explanatory model selection policy can include a threshold (e.g., a different threshold or the same threshold) for each of the plurality of metrics. The data processing system can determine the rule is satisfied responsive to or based on each of the metrics (e.g., the metrics determined for the first explanatory model) exceeding the corresponding threshold. In another example, the data processing system can determine a rule of the explanatory model selection policy is satisfied responsive to determining the prescriptivity metric for the first explanatory model is below a threshold. In another example, the data processing system can determine a rule is satisfied responsive to determining a sum or weighted sum of the metrics is greater than a threshold. The data processing system can determine rules are satisfied based on any criteria or conditions being satisfied.

In some cases, the data processing system can use a cascading approach to determine which rule of the explanatory model selection policy is satisfied. For example, responsive to determining at least one of the plurality of metrics (or a defined set of metrics) is below a threshold, the data processing system can retrieve the second explanatory model from memory and apply a combination of the first explanatory model and the second explanatory model to the first classification data point to generate new metrics (e.g., a second plurality of metrics). The data processing system can apply the rules of the explanatory model selection policy to the new metrics alone or in combination with the initially generated metrics to determine which rules are satisfied, if any.

In some cases, the data processing system can determine the explanatory model selection policy is not satisfied. The data processing system can do so responsive to determining no rule of the explanatory model selection policy is satisfied by the plurality of metrics. Responsive to determining the explanatory model selection policy is not satisfied, at operation 214, the data processing system adjusts one or more features of the machine learning model. The data processing system can adjust the one or more features of the machine learning model by retraining the machine learning model to use a different set of features or feature types to generate classifications of the same type. For example, the data processing system may retrain the machine learning model from initially using minimum account age, maximum account age, minimum monthly sum of transaction amounts, and average of monthly sum of transaction amounts to determine a credit score for an account instead of using minimum of monthly sum of transaction amounts, average of monthly sum of transaction amounts, and count of days during the end of day balance goes negative to determine the credit score. The data processing system can do so responsive to determining none of the rules of the explanatory model selection policy are satisfied by the metrics and/or a particular rule of the explanatory model selection policy is satisfied, such as a reiteration similarity metric of the first explanatory model being below a threshold or below multiple thresholds. In doing so, the data processing system can identify a machine learning model that is not generating accurate results or that is otherwise generating results that cannot be explained and adjust the configuration of the machine learning model accordingly. The data processing system can repeat this process any number of times to generate a machine learning model that is accurate and transparent with the machine learning model's predictions.

At operation 216, the data processing system selects an ensemble set of explanatory models. The data processing system can select the set of explanatory models based on the set corresponding to a satisfied rule of the explanatory model selection policy. For example, the data processing system can select both of the first explanatory model and the second explanatory model based on at least one of the metrics generated for the first explanatory model being less than a threshold and multiple metrics for a combination of the first explanatory model and the second explanatory model exceeding a threshold (e.g., a different threshold or the same threshold). The data processing system can select the set of explanatory models to use to generate explanations for outputs of the machine learning model (e.g., the specific machine learning model) that generates the first classification data point based on which the data processing system selected the set of explanatory models.

At operation 218, the data processing system applies the selected set of explanatory models. For example, the data processing system can receive a request for a classification (e.g., a credit score) of a requested type for an account from a computing device. Responsive to receiving the request, the data processing system can retrieve the machine learning model based on the machine learning model being configured to generate classifications of the requested type. The data processing system can retrieve transaction data for the account based on the request and execute the machine learning model to generate a second classification data point. The data processing system can apply the selected set of explanatory models to the second classification data point to generate an explanation for the second classification data point. The explanation can include impact values (e.g., values having a magnitude and/or a direction) of different features of the retrieved transaction data in generating the second classification data point. The data processing system can transmit the second classification data point and the explanation to the computing device that transmitted the request. The computing device can receive the second classification data point and the explanation and present the second classification data point and the explanation on a user interface on a display.

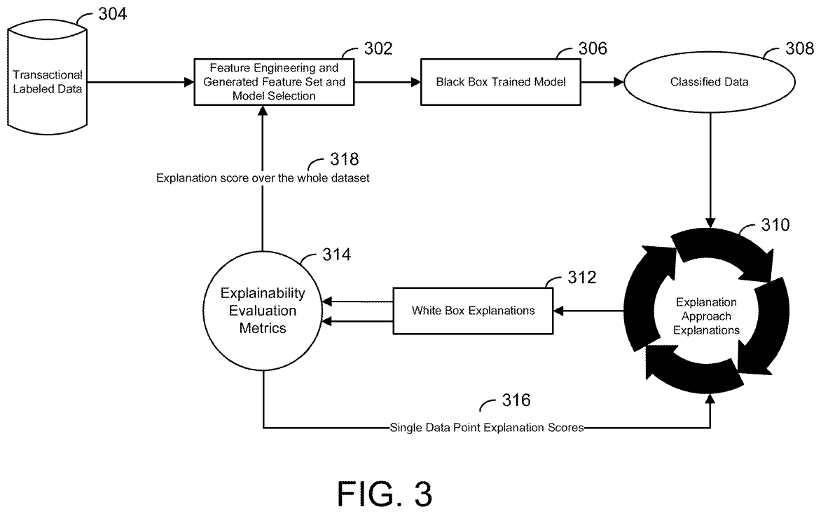

FIG. 3 illustrates a sequence diagram of a sequence 300 for explanatory model evaluation and selection, in accordance with an implementation. The sequence 300 can be performed by a data processing system (e.g., a client device or the model selection server 102, shown and described with reference to FIG. 1, a server system, etc.). The sequence 300 may include more or fewer operations and the operations may be performed in any order.

In the sequence 300, at operation 302, the data processing system retrieves or generates labeled transaction data that can be used to train one or more machine learning models to generate classifications. The data processing system can train the models to generate classification outputs, such as a loan approval or a credit score. To do so, the data processing system can select which feature types to configure the machine learning models to receive as input, such as by using feature engineering techniques to cause the machine learning models to have or at least have a defined multicollinearity given a set or defined correlation variable. The data processing system can train the machine learning model using supervised training methods. In one example, the data processing system can generate a trained machine learning model as a black box trained model 306 when performing the operation 302.

At operation 308, the data processing system executes the black box trained model 304 to generate a classification data point based on a set of transaction data used as input. The data processing system can execute the black box trained model 306 to generate a classification data point such as a credit score or a loan approval or disapproval.

At operation 308, the data processing system applies a first explanatory model (e.g., a game theory-based model) and/or a second explanatory model (e.g., a perturbation-based model) to the classification data point. In doing so, the data processing system can generate explanations 312 (e.g., white box explanations) of the reasoning behind the machine learning model's generation of the classification data point. The data processing system can generate explanations for the classification data point alone and/or for the classification data point with multiple other classification data points the data processing system generated based on a series of executions based on a dataset of transaction data (e.g., for different accounts).

At operation 314, the data processing system generates explainability evaluation metrics. In doing so, the data processing system can generate metrics such as a prescriptivity metric, a local fidelity metric, a local concordance metric, and/or a reiteration similarity metric. The data processing system can generate such metrics for the explanatory models individually and/or together. The data processing system can generate such metrics for individual classification data points that the data processing generates for a dataset at operation 316. The data processing system can repeat the metric generation process any number of times until generating an explanation score for the explanatory models individually and/or for different combinations of the explanatory models. The data processing system can select a set of explanatory models to use to generate explanations for future classifications based on the explanation scores that the data processing system generates for the explanatory models satisfying an explanatory model selection policy.

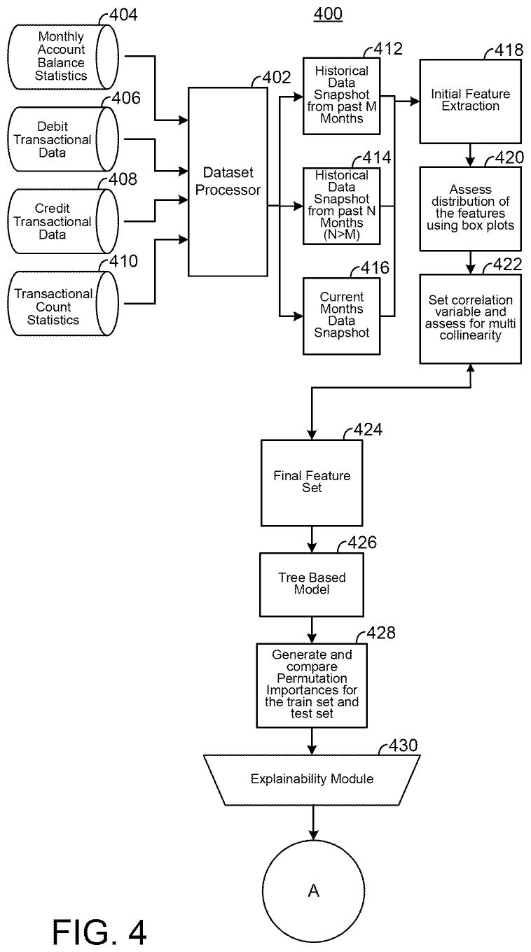

FIG. 4 illustrates an example sequence 400 for machine learning model generation, in accordance with an implementation. The sequence 400 can be performed by a data processing system (e.g., the model selection server 102, the user device 104, and/or the computing device 106, each shown and described with reference to FIG. 1, a server system, etc.). The sequence 400 may include more or fewer operations and the operations may be performed in any order. Performance of the sequence 400 may enable the data processing system to generate (e.g., automatically generate) machine learning models to generate classification outputs.

In the sequence 400, the data processing system can use or implement a dataset processor 402 (e.g., a computer or processor executing instructions stored in memory) to train a machine learning model to generate classification outputs. For example, the data processing system can collect or retrieve monthly account balance statistics 404, debit transactional data 406, credit transaction data 408, and/or transaction count statistics 410 from memory. The retrieved data 404-410 can be data of transactions performed by or through different accounts. The data processing system can divide the retrieved data by account and/or based on the transactions of the data occurring in a particular month (e.g., the previous month) 412, the transactions of the data occurring in a number of previous months 414, and/or the transactions occurring within the current month 416.

The data processing system can generate a training dataset from the retrieved (e.g., and divided) data. For example, at operation 418, the data processing system extracts specific features of different types from the retrieved data. The extracted features can be derived and/or statistical features from credit and/or debit transactions and/or averages of monthly feature values during time durations from the past M months and/or past N months. N can be greater than M. Examples of features that can be extracted are shown in the table below.

Feature Type

Minimum account age in days for all accounts
of the given account owner (by LPID)
Maximum account age in days for all accounts
of the given account owner (by LPID)
minimum of monthly sum of transaction amounts
for credit type in the past 12 months
average of monthly sum of transaction amounts
for outflow type in the past 12 months
minimum of monthly sum of transaction amounts
for outflow type in the past 12 months
average of monthly sum of transaction amounts
for credit type in the past 6 months
minimum of monthly sum of transaction amounts
for credit type in the past 6 months
minimum of monthly sum of transaction amounts
for outflow type in the past 12 months
count of days during which EOD balance
goes negative in the past 12 month(s)
minimum of End-Of-Day (EOD) balance
amount in the past 12 month(s)
coefficient of variation (standard deviation/
average) of End-Of-Day (EOD) balance amount
in the past 12 month(s)
minimum of End-Of-Day (EOD) balance
amount in the past 9 month(s)
minimum of End-Of-Day (EOD) balance
amount in the past 6 month(s)
minimum of End-Of-Day (EOD) balance
amount in the past 3 month(s)
coefficient of variation (standard deviation/
average) of End-Of-Day (EOD) balance
amount in the past 3 month(s)
minimum of End-Of-Day (EOD) balance
amount in the past 1 month(s)

At operation 420, the data processing system generates a distribution of the different features. The distribution can indicate a number of data points of the same type for each of the individual types of features. The data processing system can use the distribution to identify outliers (e.g., data points that are one or more standard deviations from the mean of the individual feature types) of the data points. At operation 422, the data processing system removes outliers that the data processing system identifies from the extracted features. The data processing system can analyze combinations of the different feature types and select a final feature set 424 that includes a set of feature types with at least a multicollinearity value that satisfies a condition (e.g., exceeds a threshold, is below a threshold, is a defined value, or is within a defined range) given a defined correlation variable.

At operation 426, the data processing system trains a machine learning model (e.g., a tree-based model, such as a light gradient boosting model, a random forest, a neural network, a deep learning model, a support vector machine, etc.) to generate a classification based on transaction data having feature types of the final feature set. At operation 428, the data processing system evaluates the machine learning model by generating and comparing permutation importance between a training dataset and a test dataset. To do so, for example, the data processing system can determine the permutation importance of individual features of the final feature set 424. The permutation importance can indicate how much each feature contributes to the prediction accuracy of the machine learning model. The data processing system can generate the permutation importance by shuffling the values of each feature (e.g., one at a time) in a dataset. The data processing system can measure how much the prediction error increases. If shuffling a feature results in a significant increase (e.g., an increase above a threshold) in the machine learning model's prediction error, that feature is considered important because the machine learning model relies on it for making accurate predictions. Conversely, if shuffling doesn't affect the prediction error much, the feature may not be important. The data processing system can generate the feature importance for individual features for the training dataset that was used train the machine learning model and for a test dataset.

The data processing system can compare the feature importance of the features between the training dataset and the test dataset. Responsive to determining a feature is more important (e.g., by at least a threshold amount) for predictions in the training dataset than the test dataset, the data processing system may determine that the machine learning model is overfitted to the training data for that particular feature. The data processing system can train the machine learning model and repeat operation 428 until determining the machine learning model is not overfitted for more than a defined number of features or is not overfitted for any features.

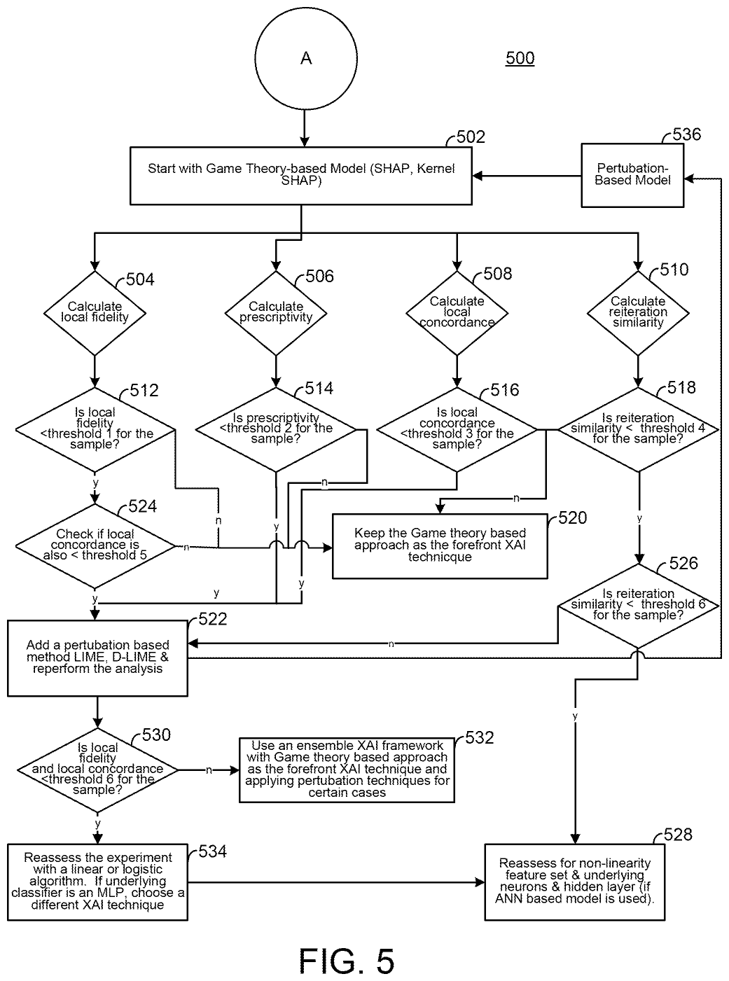

The data processing system can execute an explainability module 430 to determine which explanatory model to use to generate explanations for the machine learning model. The data processing system can select which explanatory model to use from explanatory models such as a saliency-based model (SmoothGrad, Vanilla Gradients, Guided Back propagation, Integrated Gradients, grad CAM/GradCAM++) or a model that uses counterfactuals to generate explanations. Operation 432 is described with reference to a sequence 500 with respect to FIG. 5.

FIG. 5 illustrates an example sequence 500 for explanatory model evaluation and selection, in accordance with an implementation. The sequence 500 can be performed by a data processing system (e.g., the model selection server 102, the user device 104, and/or the computing device 106, each shown and described with reference to FIG. 1, a server system, etc.). The sequence 500 may include more or fewer operations and the operations may be performed in any order. Performance of the sequence 500 may enable the data processing system to select which explanatory model or explanatory models to use to generate explanations for a particular machine learning model. The data processing system can perform the sequence 500 responsive to training or retraining the machine learning model (e.g., as described with respect to the sequence 400 of FIG. 4), for example.

In the sequence 500, at operation 502, the data processing system identifies or retrieves a game theory-based model as a first explanatory model. The data processing system executes a machine learning model (e.g., responsive to receiving a request to do so or responsive to training or retraining the machine learning model) based on transaction data of an account to generate a classification data point (e.g., a credit score or a loan approval or disapproval). At operations 504-510, the data processing system determines or calculates a local fidelity, a prescriptivity, a local concordance, and/or a reiteration similarity for the first explanatory model. The data processing system can determine these metrics (and/or different metrics, depending on the embodiment), based on the classification data point generated by the machine learning model. At operations 512-518, the data processing system determines whether the metrics are above a respective threshold (e.g., 0.4) or otherwise satisfy a condition.

Responsive to each of the metrics exceeding the corresponding threshold or otherwise satisfying a condition, at operation 520, the data processing system can determine to use the first explanatory model to generate explanations for the machine learning model. The data processing system may set a flag or setting with the first explanatory model in memory to indicate to use the first explanatory model to generate explanations for outputs by the machine learning model. However, responsive to at least one of the metrics being less than the corresponding threshold for the metric, at operation 522, the data processing system can add or identify a perturbation-based model 536 (e.g., LIME, D-LIME, etc.) as a second explanatory model and repeat the operations 504-520 either alone or in combination with the game theory-based explanatory model to generate new metrics (e.g., second metrics). Explanatory evaluation metrics can be determined using multiple explanatory models at once. Metrics can be calculated individually for each additional explanatory model. If the score improves, the chosen explanatory model is added to the base explanatory method.

In some embodiments, the data processing system may perform different or more operations depending on which explanatory evaluation metrics are less than the corresponding thresholds. For example, responsive to determining the local fidelity of the first explanatory model is less than a corresponding threshold, at operation 524 the data processing system can determine whether the local concordance is also below a corresponding threshold (e.g., 0.4). Responsive to determining the local concordance is above the threshold, the data processing system can perform the operation 520 and determine to use the first explanatory model to generate explanations for outputs by the machine learning model. Otherwise, the data processing system can perform the operation 514 and determine whether the prescriptivity metric is above a corresponding threshold. The data processing system can perform the operations 512-518 in any order and/or based on any other condition of the other operations 512-518 being satisfied.

In another example, responsive to determining at operation 518 that the reiteration similarity metric is less than a corresponding threshold, at operation 526, the data processing system can determine whether the reiteration similarity is less than another threshold (e.g., a threshold smaller than the threshold of the operation 518). Responsive to determining the reiteration similarity is greater than the threshold at operation 526, the data processing system can perform the operation 522 and add or identify a perturbation-based model (e.g., LIME, D-LIME, etc.) as a second explanatory model and repeat the operations 504-520.

However, responsive to determining the reiteration similarity is less than the threshold, at operation 528 can evaluate the feature set used for the machine learning model (e.g., the final feature set 424) and/or the structure of the machine learning model itself. For example, the data processing system can assess the feature set to determine if the feature set includes non-linear features and/or determine if the number of neurons or layers is correct or needs to be adjusted. The data processing system can determine a set of adjustments to the features that can be used as input into the machine learning model and/or the structure (e.g., the number of nodes or layers of the machine learning model). The data processing system can perform the adjustments and repeat the process until determining a rule (e.g., a particular rule) of the explanator model policy is satisfied that indicates to use an explanatory model to generate explanations for the machine learning model. The data processing system can use the systems and methods described herein to improve the accuracy and/or predictability of the machine learning model in cases in which the machine learning model operates as a black box.

In some cases, the data processing system can determine to use an ensemble of explanatory models to generate explanations for a machine learning model. For example, after adding or generating metrics for the perturbation-based model (e.g., the perturbation-based model alone or in combination with the game theory-based model), at operation 530, the data processing system can compare the metrics for the perturbation model to a threshold. In one example, the data processing system can compare the local fidelity and the local concordance for the perturbation-based model to the threshold. Responsive to determining the metrics exceed (e.g., both exceed or at least one of the metrics exceeds) the threshold, at operation 532, the data processing system can determine to use the perturbation-based model with the game theory-based model to generate explanations for the machine learning model.

However, responsive to determining the metrics are less than the threshold (e.g., are both less than the threshold or at least one of the metrics is less than the threshold), at operation 534, the data processing system can perform the sequence 500 again with a different machine learning model (e.g., a linear or logistic algorithm), or, such as in cases in which the machine learning model is a multi-layer perceptron machine learning model, use a different explanatory model to generate explanations for the machine learning model. In some cases, the data processing system can proceed to the operation 528 to adjust the configuration of the machine learning model after performing the operation 534. The data processing system may use linear or logistic algorithms to generate classifications and explanations for the classifications (e.g., in response to requests) until generating a machine learning model that satisfies the criteria of the operations 512-518, 524, and/or 530.

### Non-Limiting Examples

In a non-limiting example, credit scoring models can leverage machine learning methods, such as logistic regression, to predict whether an individual person will become default/90+ days past due (DPD) on a consumer credit card. However, many advanced artificial intelligence frameworks lack explainability to interpret each outcome from the model. For machine learning models with explainability capability, the explainability results may not provide consistent results over each run and therefore may not be stable and/or reliable.

A computer implementing the systems and methods described herein may overcome these technical deficiencies by leveraging transactional information for feature set selection along with explanatory models with metrics to evaluate and better trust the appropriate explainability frameworks. The computer can process transactional data such as account age, transaction amounts, end of day balance, and/or number of daily transactions to define a set of features. These features can be incorporated into a boosting algorithm to develop an efficient credit scoring model.

The defined features can be fed into a boosting model to predict whether an individual person will become 90+ DPD and default on a consumer credit card. The output values of the model can be defined as:

$$\begin{matrix}0 = no over 90 + DPD or charge - off in 18 months after account opening \\ 1 = over 90 + DPD or charge - off in 18 months after account opening\end{matrix}$$

The computer can develop a machine learning model (e.g., a machine learning model configured to generate credit scores) that is both accurate and interpretable. The machine learning model can a light gradient boosting model. The computer can apply one or more explainability frameworks (e.g., explanatory models) to interpret classifications by the machine learning model.

For example, an end user who is affected by machine learning may desire to contest the machine learning model's decision or check that the decision was fair. End users may have a legal “right to explanation” under the European Union's GDPR and the Equal Credit Opportunity Act in the US. Without explanations, if the model makes lots of bad loan recommendations, then it remains a mystery as to why. Incoming regulations in the European Union demand explainability for higher risk systems. Thus, the computer can use an eXplainable Artificial Intelligence (XAI) framework to generate explanations for machine learning model outputs.

An objective of a XAI framework is to provide effective explanations for black box classifiers (e.g., machine learning models). However, individual XAI methods are plagued by many defects including unstable explanations, divergence of actual implementations from the promised theoretical properties, and explanations for the wrong labels. This highlights the need to have standard and unbiased evaluation procedures for the generated explanations.

A computer implementing the systems and methods described herein can provide a clear and unambiguous way to compare and evaluate explainability methods via XAI metrics that explain black box models. The computer may do so using a methodology that quantify any individual or ensemble XAI methods (e.g., explanatory models) using explainability metrics such as, for example, (i) a local concordance of a white box model with regard to the black box model for an instance to be explained (e.g., how good the white box model is in mimicking the original black box for the sole instance x); (ii) under the constraint of explanation conciseness (e.g., the tendency of an explainability method to produce the same explanation on the same data point (e.g., reiteration similarity)); (iii) how good the explanation is when it is taken as a recipe to change a data point classification; (e.g., prescriptivity) and/or (iv) how good is the white box model in approximating the behavior of the black box model for the target sample x around its synthetic neighborhood (e.g., local fidelity).

The computer can determine explainability evaluation metrics to evaluate the quality of explanations provided by different explanatory models, such as a LIME model and a SHAP model on the same data point. The computer can evaluate the explanatory models using the same underlying model or black box classifier (e.g., a light gradient boosting algorithm). For example, the black box classifier can be a light gradient bossing model with E=50 estimators and a maximum depth of 5. Both the LIME and SHAP models can be evaluated, such as by using 5000 (or any other number) neighborhood samples for the LIME model and 5000 (or any other number) samples to compute Shapley values for the SHAP model. The computer can compare the top 10 most relevant features. In doing so, the computer can determine the LIME model and the SHAP model do not identify the same top 10 features as the most important, which is not unexpected given their different definition of feature importance.

The computer can determine which explanatory models to use using the explainability metrics. For example, the computer can run the LIME model and the SHAP model 10 times each to generate 10 explanations. The computer can determine explainability evaluation metrics (e.g., prescriptivity, reiteration similarity, local fidelity, and/or local concordance) based on the explanations.

The computer can evaluate the explainability metrics to evaluate the quality of the explanations provided by the LIME model and the SHAP model on the same data point x, using the same machine learning model f. In one example, the SHAP output prediction can be 1.66 and the LIME Output prediction can be 1 for the predicted classes. The explanations between the models can have different local fidelity and prescriptivity scores. Prescriptivity can be the ability of using an explanation (e.g., an explanation generated by XAI techniques of an instance x to identify a new synthetic instance x′ which is closer to the classification boundary than x). In this example, the SHAP model can have a high prescriptivity, showing how the explanation can be trusted proactively. Since this is not always the case with the LIME model, it is important to quantify whether the explanation can be used in a prescriptive way. In addition, the LIME model shows some instability in terms of reiteration similarity (e.g., multiple invocations of the explainer will not result in the same set of relevant features). Moreover, LIME model explanations can show an average local concordance of 0.78, which means that g(x) is not very close to the value of f (x).

In order to be trusted, an explanation may need to be stable, (e.g., the explanatory model should not provide entirely different sets of relevant features if called multiple times to explain the same instance x). Accordingly, the computer can evaluate the reiteration similarity of the models as a precondition to selecting an explanatory model.

Additionally, the computer can split data points into correctly and incorrectly classified (e.g., f(x)=y or f(x)/=y), to further determine whether the original data point classification is relevant for the observed instability. Reiteration similarity may decline with the increasing non-linearity of the classifier. However, the relation between the non-linearity (e.g., both in terms of neurons and hidden layers) and the reiteration similarity score follows a non-trivial pattern. In fact, even simpler models may experience instabilities in the explanations over multiple reiterations. It is worth noting that the explanation local fidelity for the sample of this example (e.g., in particular for the explanation provided by the SHAP model and the LIME model) is not very high (e.g., 0.762 for the LIME model and only 0.375 for the SHAP model). However, when the computer follows the indication of the explanation to reach the new boundary f(x′), it may be close.

This could happen because the local fidelity measures two different aspects at once: 1) it could be low because the white box model g is not a good model for the neighborhood N(x); or 2) the neighborhood N(x) lies close to a non-linear classification boundary, which is not fully captured by g. This example shows that the widely used local fidelity score does not capture the prescriptive use of an explanation, and it is limited in the local evaluation of the white box model.

The SHAP model may guarantee a perfect local concordance when considering all features. In the case of LIME, the local concordance may be 0.949, which is still high. However, the local fidelity of the underlying models of the SHAP model in the neighborhood of data point x may be much smaller than the one obtained by the LIME model explanations. In contrast, the SHAP model may have a better prescriptivity than the LIME model (e.g., manipulating the top ten features identified by the SHAP model as explanations produces a new point x′ with a higher chance of changing the classifier outcome).

The explainability evaluation metrics (or metrics, as described herein) can be applied on the same data point for both explanatory models (the SHAP model and the LIME model) that was used to generate the explanations to compute the reiteration similarity score, prescriptive score, local fidelity score and local concordance score for better interpretation. The SHAP model explanations can be the lead explanation model because it shows a higher reiteration similarity and local concordance prescriptive power. The LIME model may be preferred if the user has low values of most features and wants a higher local fidelity, and the underlying machine learning model is a linear model. It is worth noting that the definition of local fidelity may favor local importance and could therefore be biased toward perturbation models (e.g., LIME-like model). This may be the case because the LIME model fits the white box model g minimizing the classification loss for a neighborhood N(x), thus local fidelity may capture the optimization target of the LIME model.

Overall, by implementing the systems and methods described herein, the computer can select which explanatory model to use to generate explanations for a machine learning model. In tests of applying the systems and methods described herein on machine learning models trained for credit scoring, the LIME model was found to be highly stable for linear/logistic classifiers and for lower conciseness levels (e.g., a higher number of feature values). The SHAP model showed a high reiteration similarity, even at low conciseness. This remains a bit surprising since explainability methods have been promoted to explain artificial neural network and to be model agnostic in general. The SHAP model appears to have slightly higher reiteration similarity values on average than the LIME model. The computer can use an ensemble explainability framework with the SHAP model in forefront for explaining most of the decisions by leveraging this proposed methodology and the LIME model for certain cases. This system could be extended to any use case adopting a black box model as a classifier.

In one aspect, the present disclosure describes a system. The system can include one or more processors configured by machine-readable instructions stored in memory. Upon execution, the machine-readable instructions can cause the one or more processors to store a first explanatory model of a first model type and a second explanatory model of a second model type in the memory, the first explanatory model and the second explanatory model each configured to interpret classification predictions from a machine learning model generated based on input transaction data; execute the machine learning model using a first set of transaction data to generate a first classification data point for the first set of transaction data; apply the first explanatory model to the first classification data point to generate a first explanation for the first classification data point; generate a first plurality of metrics for the first explanatory model based on the first explanation; and responsive to the first plurality of metrics satisfying an explanatory model selection policy, apply the first explanatory model and the second explanatory model to a second classification data point output by the machine learning model based on a second set of transaction data.

In another aspect, the present disclosure describes a method. The method can include storing, by one or more processors, a first explanatory model of a first model type and a second explanatory model of a second model type in memory, the first explanatory model and the second explanatory model each configured to interpret classification predictions from a machine learning model generated based on input transaction data; executing, by the one more processors, the machine learning model using a first set of transaction data to generate a first classification data point for the first set of transaction data; applying, by the one or more processors, the first explanatory model to the first classification data point to generate a first explanation for the first classification data point; generating, by the one or more processors, a first plurality of metrics for the first explanatory model based on the first explanation; and responsive to the first plurality of metrics satisfying an explanatory model selection policy, applying, by the one or more processors, the first explanatory model and the second explanatory model to a second classification data point output by the machine learning model based on a second set of transaction data.

In another aspect, the present disclosure describes Non-transitory computer-readable media, comprising instructions that, when executed by one or more processors, cause the one or more processors to store a first explanatory model of a first model type and a second explanatory model of a second model type in the memory, the first explanatory model and the second explanatory model each configured to interpret classification predictions from a machine learning model generated based on input transaction data; execute the machine learning model using a first set of transaction data to generate a first classification data point for the first set of transaction data; apply the first explanatory model to the first classification data point to generate a first explanation for the first classification data point; generate a first plurality of metrics for the first explanatory model based on the first explanation; and responsive to the first plurality of metrics satisfying an explanatory model selection policy, apply the first explanatory model and the second explanatory model to a second classification data point output by the machine learning model based on a second set of transaction data.

### Large Language Models and Generative Artificial Intelligence

Large language models can be used to implement or enhance aspects described herein. As discussed above, replays, logs, or other data of user interactions with the digital experience can be captured. Such data can be provided as input to a large language model with a prompt to summarize what occurred. Such a summary can be provided as part of the remediation (e.g., to developers to better understand the problem). Further, the large language model can be prompted to identify designs or other changes that may be implemented to address the struggle. In addition to or instead of designs, the large language model may be configured to (e.g., with appropriate prompts and contacts) generate code or instructions (or changes to code or instructions) that address the struggle. A large language model may be used to generate user-specific and struggle-specific messages to the user (e.g., in relation to the above communications).

### Computing Environment

FIG. 6 discloses a computing environment 600 in which aspects of the present disclosure may be implemented. A computing environment 600 is a set of one or more virtual or physical computers 610 that individually or in cooperation achieve tasks, such as implementing one or more aspects described herein. The computers 610 have components that cooperate to cause output based on input. Example computers 610 include desktops, servers, mobile devices (e.g., smart phones and laptops), payment terminals, wearables, virtual/augmented/expanded reality devices, spatial computing devices, virtualized devices, other computers, or combinations thereof. In particular example implementations, the computing environment 600 includes at least one physical computer.

The computing environment 600 may specifically be used to implement one or more aspects described herein. In some examples, one or more of the computers 610 may be implemented as a user device, such as a mobile device, and others of the computers 610 may be used to implement aspects of a machine learning framework useable to train and deploy models exposed to the mobile device or provide other functionality, such as through exposed application programming interfaces.

The computing environment 600 can be arranged in any of a variety of ways. The computers 610 can be local to or remote from other computers 610 of the environment 600. The computing environment 600 can include computers 610 arranged according to client-server models, peer-to-peer models, edge computing models, other models, or combinations thereof.

In many examples, the computers 610 are communicatively coupled with devices internal or external to the computing environment 600 via a network 690. The network 690 is a set of devices that facilitate communication from a sender to a destination, such as by implementing communication protocols. Example networks 690 include local area networks, wide area networks, intranets, or the Internet.

In some implementations, computers 610 can be general-purpose computing devices (e.g., consumer computing devices). In some instances, via hardware or software configuration, computers 610 can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use.

Many example computers 610 include one or more processors 612, memory 614, and one or more interfaces 618. Such components can be virtual, physical, or combinations thereof.

The one or more processors 612 are components that execute instructions, such as instructions that obtain data, process the data, and provide output based on the processing. The one or more processors 612 often obtain instructions and data stored in the memory 614. The one or more processors 612 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the one or more processors 612 include at least one physical processor implemented as an electrical circuit. Example providers processors 612 include INTEL, AMD, QUALCOMM, TEXAS INSTRUMENTS, and APPLE.

The memory 614 is a collection of components configured to store instructions 616 and data for later retrieval and use. The instructions 616 can, when executed by the one or more processors 612, cause execution of one or more operations that implement aspects described herein. In many examples, the memory 614 is a non-transitory computer-readable medium, such as random access memory, read only memory, cache memory, registers, portable memory (e.g., enclosed drives or optical disks), mass storage devices, hard drives, solid state drives, other kinds of memory, or combinations thereof. In certain circumstances, transitory memory 614 can store information encoded in transient signals.

The one or more interfaces 618 are components that facilitate receiving input from and providing output to something external to the computer 610, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors, such as those using the Global Positioning System), other input components, or combinations thereof (e.g., a touch sensitive display). The one or more interfaces 618 can include components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as WI-FI, cellular, BLUETOOTH, ZIGBEE, or other protocols). One or more of the one or more interfaces 618 can facilitate connection of the computing environment 600 to a network 690.

The computers 610 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries (e.g., libraries that provide functions for obtaining, processing, and presenting data), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Machine Learning Framework

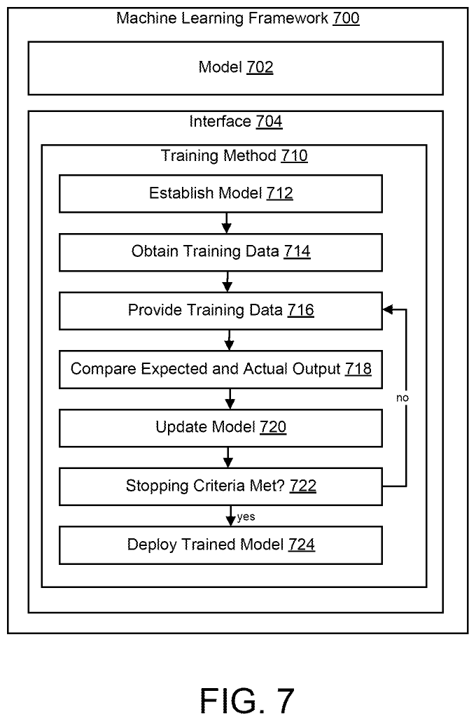

FIG. 7 illustrates an example machine learning framework 700 that techniques described herein may benefit from. A machine learning framework 700 is a collection of software and data that implements artificial intelligence trained to provide output, such as predictive data, based on input. Examples of artificial intelligence that can be implemented with machine learning ways include neural networks (including recurrent neural networks), language models (including so-called “large language models”), generative models, natural language processing models, adversarial networks, decision trees, Markov models, support vector machines, genetic algorithms, others, or combinations thereof. A person of skill in the art, having the benefit of this disclosure, will understand that these artificial intelligence implementations need not be equivalent to each other and may instead select from among them based on the context in which they will be used. Machine learning frameworks 700 or components thereof are often built or refined from existing frameworks, such as TENSORFLOW by GOOGLE, INC. or PYTORCH by the PYTORCH community.

The machine learning framework 700 can include one or more models 702 that are the structured representation of learning and an interface 704 that supports use of the model 702.

The model 702 can take any of a variety of forms. In many examples, the model 702 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 702 can include a representation of memory (e.g., providing long short-term memory functionality). Where the set includes more than one model 702, the models 702 can be linked, cooperate, or compete to provide output.

The interface 704 can include software procedures (e.g., defined in a library) that facilitate the use of the model 702, such as by providing a way to establish and interact with the model 702. For instance, the software procedures can include software for receiving input, preparing input for use (e.g., by performing vector embedding, such as using Word2Vec, BERT, or another technique), processing the input with the model 702, providing output, training the model 702, performing inference with the model 702, fine tuning the model 702, other procedures, or combinations thereof.

In an example implementation, interface 704 can be used to facilitate a training method 710 that can include operation 712. Operation 712 includes establishing a model 702, such as initializing a model 702. The establishing can include setting up the model 702 for further use (e.g., by training or fine tuning). The model 702 can be initialized with values. In examples, the model 702 can be pretrained. Operation 714 can follow operation 712. Operation 714 includes obtaining training data. In many examples, the training data includes pairs of input and desired output given the input. In supervised or semi-supervised training, the data can be prelabeled, such as by human or automated labelers. In unsupervised learning the training data can be unlabeled. The training data can include validation data used to validate the trained model 702. Operation 716 can follow operation 714. Operation 716 includes providing a portion of the training data to the model 702. This can include providing the training data in a format usable by the model 702. The framework 700 (e.g., via the interface 704) can cause the model 702 to produce an output based on the input. Operation 718 can follow operation 716. Operation 718 includes comparing the expected output with the actual output. In an example, this can include applying a loss function to determine the difference between expected and actual. This value can be used to determine how training is progressing. Operation 720 can follow operation 718. Operation 720 includes updating the model 702 based on the result of the comparison. This can take any of a variety of forms depending on the nature of the model 702. Where the model 702 includes weights, the weights can be modified to increase the likelihood that the model 702 will produce correct output given an input. Depending on the model 702, backpropagation or other techniques can be used to update the model 702. Operation 722 can follow operation 720. Operation 722 includes determining whether a stopping criterion has been reached, such as based on the output of the loss function (e.g., actual value or change in value over time). In addition to, or instead, whether the stopping criterion has been reached can be determined based on a number of training epochs that have occurred or an amount of training data that has been used. In some examples, satisfaction of the stopping criterion can include If the stopping criterion has not been satisfied, the flow of the method can return to operation 714. If the stopping criterion has been satisfied, the flow can move to operation 722. Operation 722 includes deploying the trained model 702 for use in production, such as providing the trained model 702 with real-world input data and produce output data used in a real-world process. The model 702 can be stored in memory 614 of at least one computer 610, or distributed across memories of two or more such computers 610 for production of output data (e.g., predictive data).

### Application of Techniques

Techniques herein may be applicable to improving technological processes of a financial institution, such as technological aspects of transactions (e.g., resisting fraud, entering loan agreements, transferring financial instruments, or facilitating payments). Although technology may be related to processes performed by a financial institution, unless otherwise explicitly stated, claimed inventions are not directed to fundamental economic principles, fundamental economic practices, commercial interactions, legal interactions, or other patent ineligible subject matter without something significantly more.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage training of a machine learning model with a diverse set of training data. Further, the policy can encourage testing for, and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system, comprising:
one or more processors configured by machine-readable instructions stored in memory, wherein, upon execution, the machine-readable instructions cause the one or more processors to:
store a first explanatory model of a first model type and a second explanatory model of a second model type in the memory, the first explanatory model and the second explanatory model each configured to interpret classification predictions from a machine learning model generated based on input transaction data;
execute the machine learning model using a first set of transaction data to generate a first classification data point for the first set of transaction data;
generate a first plurality of metrics for the first explanatory model by applying the first explanatory model to the first classification data point; and
responsive to the first plurality of metrics satisfying an explanatory model selection policy, apply the first explanatory model and the second explanatory model to a second classification data point output by the machine learning model based on a second set of transaction data to generate an explanation for the second classification data point.

2. The system of claim 1, wherein the machine-readable instructions cause the one or more processors to execute the machine learning model by executing a gradient boosting model; and
wherein the machine-readable instructions cause the one or more processors to execute the first explanatory model and the second explanatory model by executing a Shapley Additive exPlanations (SHAP) model and a Local Interpretable Model-Agnostic Explanations (LIME) model.

3. The system of claim 1, wherein the machine-readable instructions cause the one or more processors to generate the first plurality of metrics for the first explanatory model by:
generating a prescriptivity metric, a local fidelity metric, a local concordance metric, and a reiteration similarity metric for the first explanatory model.

4. The system of claim 3, wherein the first explanatory model comprises a Shapley Additive exPlanations (SHAP) model, and wherein the machine-readable instructions cause the one or more processors to determine the first plurality of metrics satisfy the explanatory model selection policy by:
comparing the prescriptivity metric for the first explanatory model to a first threshold, the local fidelity metric for the first explanatory model to a second threshold, the local concordance metric for the first explanatory model to a third threshold, and the reiteration similarity metric for the first explanatory model to a fourth threshold; and
determining at least one of the prescriptivity metric, the local fidelity metric, the local concordance metric, or the reiteration similarity metric for the first explanatory model is less than a corresponding threshold;
responsive to determining at least one metric exceeds the corresponding threshold, applying the second explanatory model to the first classification data point with the first explanatory model to generate a second plurality of metrics for the first classification data point, the second explanatory model comprising a Local Interpretable Model-Agnostic Explanations (LIME) model; and
determining the second plurality of metrics satisfy a condition.

5. The system of claim 4, wherein the machine-readable instructions cause the one or more processors to determine the second plurality of metrics satisfy the condition based on at least one of a second local fidelity of the second plurality of metrics or a second local concordance of the second plurality of metrics being less than a threshold.

6. The system of claim 1, wherein the first explanatory model comprises a Shapley Additive exPlanations (SHAP) model and the second explanatory model comprises a Local Interpretable Model-Agnostic Explanations (LIME) model, and wherein the machine-readable instructions cause the one or more processors to:
select a first set including the first explanatory model and the second explanatory model to apply to the second classification data point from a group of sets of explanatory models based on the first plurality of metrics, the group of sets of explanatory models comprising the first set including the first explanatory model and the second explanatory model, a second set including only the first explanatory model, and a third set including only the second explanatory model.

7. The system of claim 6, wherein the first plurality of metrics comprises a prescriptivity metric, a local fidelity metric, a local concordance metric, and a reiteration similarity metric, and wherein the explanatory model selection policy comprises a separate rule for each of the first set, the second set, and the third set, each rule configured to be satisfied by a different set of values for the first plurality of metrics, and
wherein the machine-readable instructions cause the one or more processors to select the first set of the first explanatory model and the second explanatory model based on the first plurality of metrics satisfying the rule for the first set.

8. The system of claim 6, wherein the first plurality of metrics comprises a prescriptivity metric, a local fidelity metric, a local concordance metric, and a reiteration similarity metric, and wherein the explanatory model selection policy comprises a separate rule for each of the first set, the second set, and the third set, each rule configured to be satisfied by a different set of values for the first plurality of metrics;
wherein the machine-readable instructions cause the one or more processors to:
apply weights to the first plurality of metrics based on types of the first plurality of metrics; and
select the first set of the first explanatory model and the second explanatory model based on the weighted first plurality of metrics satisfying the rule for the first set.

9. The system of claim 8, wherein the machine-readable instructions cause the one or more processors to:
select the weights to apply to the first plurality of metrics based on a machine learning model type of the machine learning model.

10. The system of claim 6, wherein the first plurality of metrics comprises a prescriptivity metric, a local fidelity metric, a local concordance metric, and a reiteration similarity metric, and wherein the explanatory model selection policy comprises a separate rule for each of the first set, the second set, and the third set, each rule configured to be satisfied by a different set of values for the first plurality of metrics;
wherein the machine-readable instructions cause the one or more processors to:
select the first set of the first explanatory model and the second explanatory model based on a defined set of the first plurality of metrics having values below a corresponding threshold.

11. A method, comprising:
storing, by one or more processors, a first explanatory model of a first model type and a second explanatory model of a second model type in memory, the first explanatory model and the second explanatory model each configured to interpret classification predictions from a machine learning model generated based on input transaction data;
executing, by the one more processors, the machine learning model using a first set of transaction data to generate a first classification data point for the first set of transaction data;
generating, by the one or more processors, a first plurality of metrics for the first explanatory model by applying the first explanatory model to the first classification data point; and
responsive to the first plurality of metrics satisfying an explanatory model selection policy, applying, by the one or more processors, the first explanatory model and the second explanatory model to a second classification data point output by the machine learning model based on a second set of transaction data to generate an explanation for the second classification data point.

12. The method of claim 11, wherein generating the first plurality of metrics for the first explanatory model comprises:
generating, by the one or more processors, a prescriptivity metric, a local fidelity metric, a local concordance metric, and a reiteration similarity metric for the first explanatory model.

13. The method of claim 12, wherein the first explanatory model comprises a Shapley Additive exPlanations (SHAP) model, and wherein determining the first plurality of metrics satisfy the explanatory model selection policy comprises:
comparing, by the one or more processors, the prescriptivity metric for the first explanatory model to a first threshold, the local fidelity metric for the first explanatory model to a second threshold, the local concordance metric for the first explanatory model to a third threshold, and the reiteration similarity metric for the first explanatory model to a fourth threshold; and
determining, by the one or more processors, at least one of the prescriptivity metric, the local fidelity metric, the local concordance metric, or the reiteration similarity metric for the first explanatory model is less than a corresponding threshold;
responsive to determining at least one metric exceeds the corresponding threshold, applying, by the one or more processors, the second explanatory model to the first classification data point with the first explanatory model to generate a second plurality of metrics for the first classification data point, the second explanatory model comprising a Local Interpretable Model-Agnostic Explanations (LIME) model; and
determining, by the one or more processors, the second plurality of metrics satisfy a condition.

14. The method of claim 13, comprising:
determining, by the one or more processors, the second plurality of metrics satisfy the condition based on at least one of a second local fidelity of the second plurality of metrics or a second local concordance of the second plurality of metrics being less than a threshold.

15. The method of claim 11, wherein the first explanatory model comprises a Shapley Additive exPlanations (SHAP) model and the second explanatory model comprises a Local Interpretable Model-Agnostic Explanations (LIME) model, and the method comprising:
selecting, by the one or more processors, a first set including the first explanatory model and the second explanatory model to apply to the second classification data point from a group of sets of explanatory models based on the first plurality of metrics, the group of sets of explanatory models comprising the first set including the first explanatory model and the second explanatory model, a second set including only the first explanatory model, and a third set including only the second explanatory model.

16. The method of claim 15, wherein the first plurality of metrics comprises a prescriptivity metric, a local fidelity metric, a local concordance metric, and a reiteration similarity metric, and wherein the explanatory model selection policy comprises a separate rule for each of the first set, the second set, and the third set, each rule configured to be satisfied by a different set of values for the first plurality of metrics, and
wherein the method comprises selecting, by the one or more processors, the first set of the first explanatory model and the second explanatory model based on the first plurality of metrics satisfying the rule for the first set.

17. The method of claim 16, wherein the first plurality of explanatory evaluation metrics comprises a prescriptivity metric, a local fidelity metric, a local concordance metric, and a reiteration similarity metric, and wherein the explanatory model selection policy comprises a separate rule for each of the first set, the second set, and the third set, each rule configured to be satisfied by a different set of values for the first plurality of metrics;
wherein the method comprises:
applying, by the one or more processors, weights to the first plurality of metrics based on types of the first plurality of metrics; and
selecting, by the one or more processors, the first set of the first explanatory model and the second explanatory model based on the weighted first plurality of metrics satisfying the rule for the first set.

18. Non-transitory computer-readable media, comprising instructions that, when executed by one or more processors, cause the one or more processors to:
store a first explanatory model of a first model type and a second explanatory model of a second model type in memory, the first explanatory model and the second explanatory model each configured to interpret classification predictions from a machine learning model generated based on input transaction data;
execute the machine learning model using a first set of transaction data to generate a first classification data point for the first set of transaction data;
generate a first plurality of explanatory evaluation metrics for the first explanatory model by applying the first explanatory model to the first classification data point; and
responsive to the first plurality of explanatory evaluation metrics satisfying an explanatory model selection policy, apply the first explanatory model and the second explanatory model to a second classification data point output by the machine learning model based on a second set of transaction data.

19. The non-transitory computer-readable media of claim 18, wherein the instructions cause the one or more processors to execute the machine learning model by executing a gradient boosting model; and
wherein the machine-readable instructions cause the one or more processors to execute the first explanatory model and the second explanatory model by executing a Shapley Additive exPlanations (SHAP) model and a Local Interpretable Model-Agnostic Explanations (LIME) model.

20. The non-transitory computer-readable media of claim 18, wherein the instructions cause the one or more processors to generate the first plurality of metrics for the first explanatory model by:
generating a prescriptivity metric, a local fidelity metric, a local concordance metric, and a reiteration similarity metric for the first explanatory model.
